(19) United States
(12) Patent Application Publication
(10) Pub. No.: US 2021/0012379 A1
(43) Pub. Date: Jan. 14, 2021

(54) System and Method for Providing Opt-In Digital Marketing

(71) Applicant: Bert Pope, Tallahassee, FL (US)

(72) Inventor: Bert Pope, Tallahassee, FL (US)

(21) Appl. No.: 16/924,069

(22) Filed: Jul. 8, 2020

Related U.S. Application Data
(60) Provisional application No. 62/871,395, filed on Jul. 8, 2019.

(51) Int. Cl. G06Q 30/02; G06Q 20/36

(52) U.S. Cl. CPC G06Q 30/0258; G06Q 30/0277; G06Q 30/0236; G06Q 20/3678; G06Q 30/0215; G06Q 30/0271

(57) ABSTRACT

An opt-in digital marketing method which allows users to access content free of advertisements with an option to engage with advertisement through a separate and distinct plug-in. To access plug-in content user will click on an icon to display a series of advertisement offers. Each advertisement offer is provided by a third party advertiser and allows the user to interact with the offer often providing a response incentive for such interaction, such as a coupon, discount or free gift. The method provides the user with a wallet page that stores all response incentives received and tracks whether the user has redeemed the incentive. Additionally, the present method allows a user to share or save advertisement offers.

### CROSS-REFERENCES TO RELATED APPLICATIONS

This non-provisional patent application claims the benefit, pursuant to 37 C.F.R. § 1.53(c), of a previously-filed provisional application. The provisional application was filed on Jul. 8, 2019, and was assigned Ser. No. 62/871,395. The provisional application listed the same inventor.

### STATEMENT REGARDING FEDERALLY SPONSORED RESEARCH OR DEVELOPMENT

Not Applicable

### MICROFICHE APPENDIX

Not Applicable

### BACKGROUND

### 1. Field of the Invention

This invention relates to the field of digital marketing. Specifically, the invention relates to a digital marketing platform that requires user initiation for display of promotional advertisements and provides a reward in return for opting in to said advertisements.

### 2. Description of the Related Art

The need for opt-in digital marketing occurs on internet outlets, such as social media platforms, applications and websites. Currently, users are bombarded with integrated advertisements when using web pages, social media sites or applications that allow advertisers to post on the graphical user interface that is shown to the user. Users are constantly diverted from their news feed or other interface they are interacting with and essentially forced to look at the advertisement. A typical advertisement on a web page or application is illustrated in FIG. 1. The prior art social media platform has a graphical user interface 10 that includes prior art content 14 such as a news feed. The news feed often includes statuses from various friends of user 50. User 50 may also post his or her own status update, which would also be displayed in news feed. User 50 may also react to his or her friends' posts, typically through liking, commenting, or sharing said post. As can be seen, prior art social media graphical user interface 10 incorporates advertisement 12 directly into user's 50 news feed. Thus, user's news feed 14 is interrupted by the presence of prior art advertisement 12. This is typical of most social media graphical user interfaces, wherein advertisements are scattered through a user's news feed 14. This method of advertising can be burdensome, distracting, and even bothersome to the user, who likely uses the social media website or application to connect with friends rather than be exposed to advertisements. However, there is still a need to use advertisements to financially support the social media mobile platform.

For the foregoing reasons, there is a need for an advertising platform within internet outlets that allow the user to choose to engage with advertisers on an optional basis. It is advantageous for the user to choose what advertisers to engage with and when, rather than allowing the content provider to have control of what, where, and when advertisements appear on users' web pages, news feeds, and/or other social media interface. The present invention solves these problems by providing a user-controlled advertising page within internet outlets, wherein advertisers are still able to promote their products/services, but only to those that willingly choose to engage with the advertiser.

### SUMMARY

The present invention is directed to a digital web-based marketing platform that requires the user to “opt-in” prior to viewing the advertisement. A separately loaded plug-in component apart from the application platform includes a series of advertising offers in which each advertisement has its own thumbnail that their advertisement offer is displayed upon. The most popular advertisements may be displayed first on the advertisement page. Users choose which advertisements they would like to engage with. The advertiser requires the user to confer a benefit onto them in order to receive a response incentive, perhaps by requesting that the user enter their contact information or answer questions related to a service or product. Once the user engages with the advertiser per the advertiser's request, the user is rewarded with a response incentive such as a coupon, promotion code, discount offer, gift, or the user can purchase the product or service (point-of-sale) using the discounts provided.

It is in this manner that the advertisements are hidden from users who are accessing the applications content such as a newsfeed, video or images or other application content. Users must select or click on a prompt on the application or webpage, perhaps through an icon with a “$” symbol, to display the advertising offers or plug-in content. Thus, no advertisements would be present anywhere on the application graphical display and only would appear on the plug-in graphical display.

The present method also allows users to store all response incentives in one place, the wallet page. A user can access the wallet page by way of an icon that the user can click on from the applications main page. The wallet can store all the response incentives a user has obtained. The wallet may also have a feature that allows the user to identify whether the reward has expired, been used, or is still available. Further, the individual advertisement offers may have a share feature, wherein the user can copy and paste the link to the advertisement or share via the internet platform the advertisement obtained through e-mail or other communication mechanism.

The previously described embodiment of the method has many advantages. The method allows advertisers to advertise effectively in connection with any application via a separate plug-in component while simultaneously allowing a user to choose which advertisements he or she may want to engage with. Further, the user is rewarded with a response incentive after engaging with the advertisement offer. This response incentive may be a gift, promo code, discount, etc. Finally, the user may share advertisement offers and save their collected response incentives using the “wallet” feature. These and other features, aspects, and advantages of the present method will become better understood with reference to the following description, appended claims, and accompanying drawings.

The embodiments described are preferred due to their advantages over the prior art but are not required in all embodiments of the invention. Importantly, the invention does not require that all the advantageous features described herein be incorporated into every embodiment of the invention.

The preceding description contains significant detail regarding the novel aspects of the present invention. It should not be construed, however, as limiting the scope of the invention but rather as providing illustrations of the preferred embodiments of the invention. As an example, the device may feature a share capability but is not required to.

### BRIEF DESCRIPTION OF THE DRAWINGS

FIG. 1 is an exemplary depiction of a social media webpage, showing a prior art advertisement on a user's newsfeed.

FIG. 2 is an exemplary depiction of a graphical user interface, showing application content coupled with the icon leading to the opt-in digital marketing system.

FIG. 3 is an exemplary depiction of a graphical user interface, showing the user screen of the opt-in digital marketing system and thus, plug-in content.

FIG. 4 is an exemplary depiction of a graphical user interface, showing an exploded view of an advertisement present on the opt-in digital marketing system.

FIG. 5 is an exemplary depiction of a graphical user interface, showing an exploded view of an alternative advertisement on the opt-in digital marketing system.

FIG. 6 is an exemplary depiction of a graphical user interface, showing the wallet feature of the opt-in digital marketing system.

FIG. 7 is an exemplary depiction of a graphical user interface, showing the share feature of the opt-in digital marketing system.

FIG. 8 is a perspective view, showing the presence of the opt-in digital marketing system on a mobile device.

FIG. 9 is a high level block diagram, showing the hardware and software components of the present invention.

FIG. 10 is a schematic view, depicting the manners in which a user may obtain access to the present invention.

FIG. 11 is a flow chart, showing the present invention.

### REFERENCE NUMERALS IN THE DRAWINGS

10 prior art graphical user interface
12 prior art advertisement
14 prior art content (news feed)
20 application graphical user interface
22 advertisement
24 content
26 icon
27 plug-in graphical user interface
28 opt-in offer page
30 advertising offer
32 interactive pop-up
34 opt-in wallet page
36 response incentive
38 share pop-up
40 mobile device
42 plug-in component
44 database
46 computer device
48 external website
50 user
52 content hosting server
54 network
55 host application
56 laptop computer
58 tablet computer
60 desktop computer
62 printer
64 wireless router
66 cellular service provider

### DETAILED DESCRIPTION

Although reference is made to particular features of the invention throughout this disclosure, it is to be understood that the invention includes all possible combinations of these particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The present method provides a plug-in software component that communicates with a software application (host application) to allow a user to experience an application's services and content free of advertisements, while still providing the advertising offers through an opt-in offer page, as described herein. Although this method is shown in conjunction with a social media platform and application, the reader will understand that the present method can be used with any software application that uses or relies on advertisements. The method provides a more positive experience for users with the application itself and the advertisements, therefor leaving the user feeling more positively towards the app and advertisers.

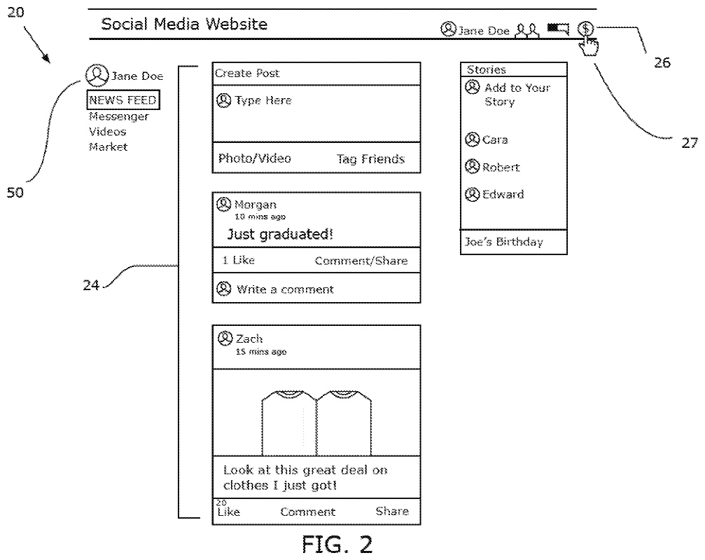

In FIG. 2, content 24 (in this case, a news feed) generated by social media platform is shown on an application graphical user interface 20 without any advertisements. The depiction shows a graphical display of information sent over a network. A user employs a computing device (such as a desktop computer, tablet computer, or smart phone) to access the website or mobile application. When the user opens the mobile application, in one example, a display such as shown in FIG. 2 appears. The index page or main page of software application includes content 24 without advertisements. To opt-in to view advertisements, user 50 can select icon 26 (an “opt-in icon”). Icon 26 “takes” users to the marketing platform plug-in 42 (not shown). Thus, allowing user 50 to access the plug-in functionality. The host application can exchange data with plug-in and the user is provided with a separate page displaying advertising offers 30 for a user.

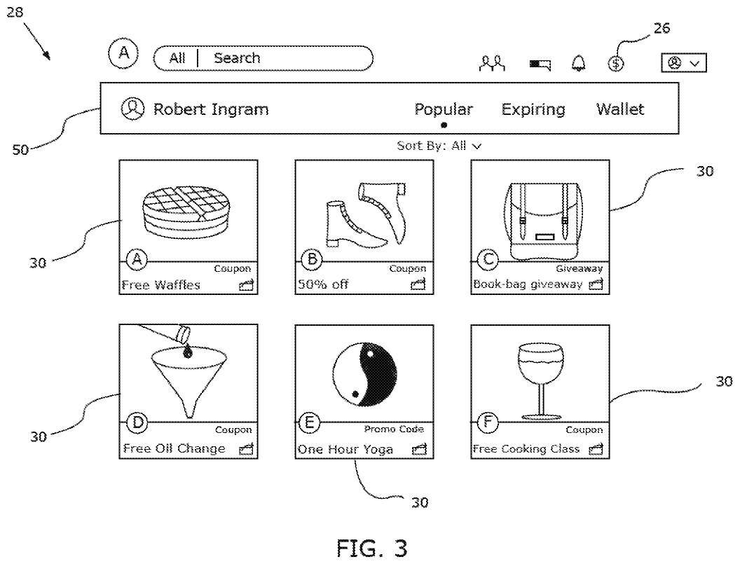

FIG. 3 illustrates an exemplary opt-in offer page 28, which is the preferable method of offering advertising offers 30. Opt-in offer page 28, is an example of a plug-in generated page that appears to user 50 after selecting icon 26 on the application graphical user interface 20 (not shown). The reader will appreciate that, while opt-in offer page 28 is shown as a plug-in page for a social media graphical user interface 20, plug-in and therefore, opt-in offer page 28, may be used in conjunction with any website or host application that uses advertisements. The advantage of providing a separate plug-in for all advertisements is two-fold. First, user 50 will be able to experience the applications content 24 without being interrupted or distracted by unwanted advertisements. Second, those users 50 that choose to select the “opt-in” icon 26 are choosing by their own free will to engage with advertisers by viewing the various advertising offers 30 on plug-in graphical user interface 27. On any given website or application, advertising offers 30 on opt-in offer page 28 are intended to replace integrated advertisements 22 delivered with the content of the application in the prior art. After a user completes a session on the mobile application, the user is more likely to feel positive about the mobile application, because the application put the user in control of the interactions along with offering a streamlined experience.

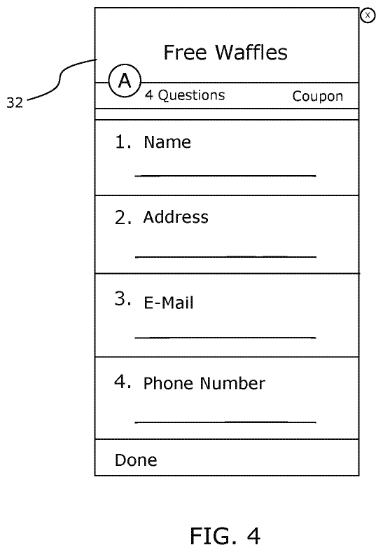

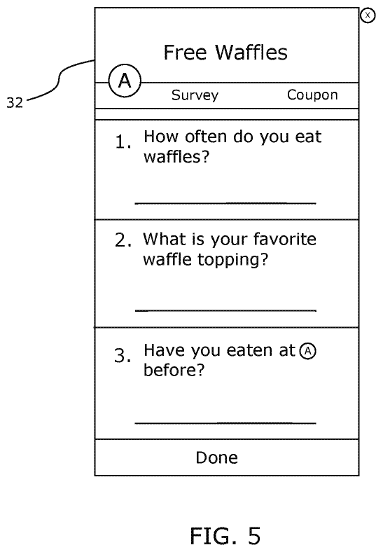

The opt-in offer page 28 is generated through a plug-in for the host application 55 (not shown). User's will be encouraged to interact with advertisements accessed on offer page 28 through the host application. A third-party advertiser may purchase space for an advertising offer 30 on the offer page 28 from the owner of the marketing platform (or host application). In one embodiment, advertising offers 30 are tiles that display a response incentive or benefit to be conferred onto user 50 once he or she chooses to engage with any particular advertising offer 30. Advertising offers 30 may be displayed in a formation of “tiles” that resembles a “tile wall,” wherein many advertising tiles can be displayed to user 50 at once. Advertising offer 30 may be for anything the advertiser chooses, including a giveaway of a product or service, a discount code, a promotion code, a coupon, or the like. For example, user 50 may click the first advertising tile depicted in FIG. 3, which offers free waffles from company “A.” User 50 would then be prompted to answer questions, enter contact information, or perform another simple task to receive free waffles—in one example (see FIGS. 4-5). These users 50 (consumers) will feel empowered by their own choice to engage with advertisers and as such may be more likely to engage with the same advertisers in the future and ultimately purchase their products or services. A share link may be present on each advertising offer 30 such that user 50 may notify other users of the offer present on the advertising tile. Advertising offers 30 on opt-in offer page 28 may be sorted in different orders, for example by most popular first, expiring first, or simply by displaying “all” advertising tiles 30.

An algorithm may be employed to arrange the offers 30 in a manner with the most popular (advertisement with the most clicks) rising to the top of the tile wall. In another embodiment the offers 30 may rise to the top of the tile wall based on length of time a user engages with the advertisement (or tile) or a user rating. In the example of the user rating, the plug-in would track ratings and adjust tiles based on overall user rankings or a combination of overall user rankings and that user's friend or acquaintance user rankings for the advertisements. The plug-in would track data associated with each advertising offer 30—such as the number of clicks made by users on advertising offer 30. The plug-in would automatically update the tile wall by rearranging the advertising offers 30 as user's either clicked on or engaged with the advertising offers 30. It would be in this manner that the user would automatically see the advertising offers 30 at the top of the page that are the most popular when they navigated to the offer page 28. Additionally, the present method would allow a user to manually filter the advertising offers 30. The filters could consist of many different data entries—such as type of product or service, advertiser name, most recent, highest rated, free giveaways, coupons, etc. The reader will appreciate that any known filter could be employed to allow the user easy access to the advertising offers 30 that the user wishes to engage with at a certain moment.

FIGS. 4-5 illustrate the preferred display after user 50 (not shown) clicks on any specific advertising offer 30 (not shown). In this example, a pop-up 32 (or advertising content) appears with a questionnaire. User 50 can answer the prompted questions. The questions could be, as in FIG. 4, contact information that the advertiser wishes to receive from the consumer/user. Alternatively, as in FIG. 5, the questions may be related to the promotion, giveaway, gift, or discount good or service the consumer/user is seeking to receive. For example, where a user clicks on an advertising tile for free waffles, the pop-up 32 may ask the user questions such as “how often do you eat waffles?” and “what is your favorite topping?” User 50 would then answer the questions, and that data is sent back to the advertiser who purchased the advertising space (tile). Additionally, the advertising offers 30 may include a link to the external website of the advertiser—providing the advertiser with another advantage. Again, additional advantage of this system for the advertiser is that the user is more invested with the product or service being advertised and therefore more likely to purchase the advertised goods or services or simply remember the trademark associated with the product or service. Additionally, even if the user does not purchase the goods or services, the advertiser may still have collected valuable information from the user—that the user voluntarily submitted.

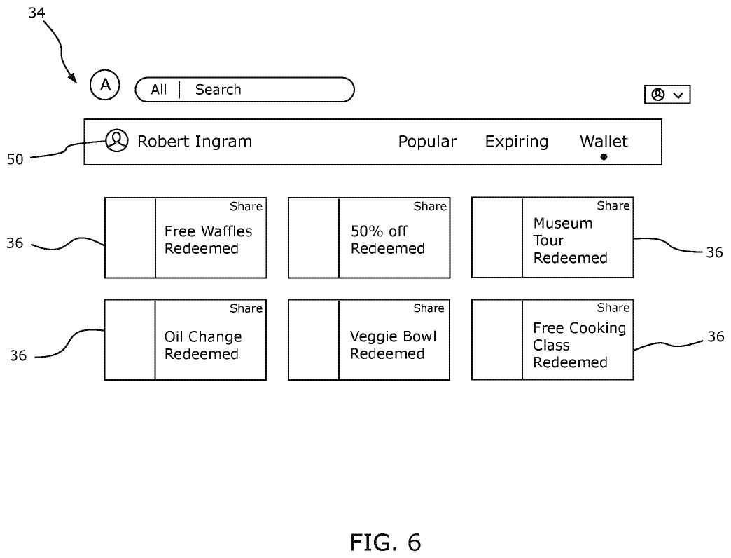

FIG. 6 illustrates the preferable display for opt-in wallet page 34. This page is a separate feature of the present method provided by the plug-in. The plug-in automatically saves the response incentive 36 to the user's wallet page 34 after the user completes the advertiser's survey or questionnaire. The wallet page 34 displays user's 50 response incentives 36. Response incentives 36 are the benefits conferred onto user 50 by an advertiser in exchange for completing offer questionnaire pop-up 32 (or other incentive program). The information collected from user is sent to the third-party advertiser in exchange for the reward. Each response incentive 36 will preferably display on user's 50 screen in a tile-like formation, such that user 50 may view various response incentives 36 at once. Response incentives 36 will preferably display whether the reward has been redeemed or not yet and what response incentive consists of, such as “free waffles.” A share link may be present on each response incentive 36, which would allow user 50 to notify other users of the advertising offer 30 that provided the benefit to user 50.

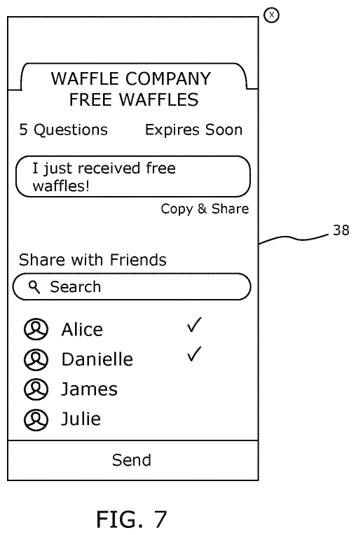

FIG. 7 illustrates the preferred pop-up display for share pop-up 38. User clicks on a “share” link in either advertising offer 30 or response incentive 36 (both not shown) in order to prompt share pop-up 38. Share pop-up 38 enables user 50 to share advertising offers 30 with other users that he or she thinks may be interested in the respective offer. User 50 may share this link with his or her friends on social media news feed, e-mail, or by copying and pasting the link and sending it via any digital communication means. Again, this provides the advantage of users on a social media website or application making the first contact with a particular advertiser by way of another user, rather than being targeted by random advertisements that are integrated into their news feeds or other content 24.

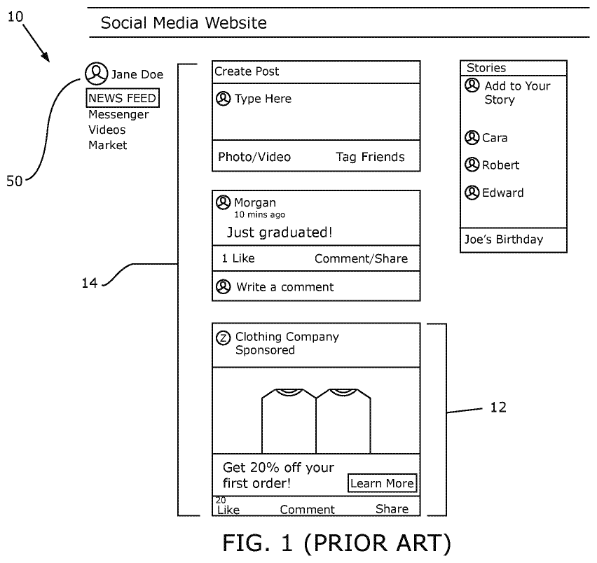

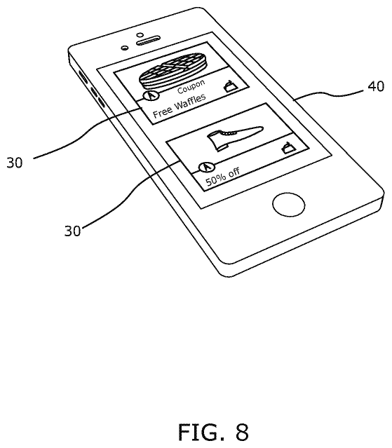

FIG. 8 illustrates a typical mobile device 40 and the display of advertising offers 30. Preferably, advertising offers 30 would be displayed on mobile device 40 such that user 50 (not shown) would scroll up and down using a finger touch on the touch screen of mobile device 40. This allows user 50 to choose when to begin and cease viewing advertising offers 30. Additionally, tiles may be arranged that the view shows more than one advertising offer 30 side-by-side in the view. In any view though, the present method allows for the offers or tiles to be manually filtered and/or filtered by the application itself based on data such as the number of clicks or length of user engagement as described above. The most popular tiles thereby rising to the top of the tile wall or display. This method is advantageous over the prior art because the user has control over how many and which advertising offers 30 he or she chooses to engage with, as opposed to being required to scroll through advertisements that are integrated into user's 50 content 24, as depicted in FIG. 1.

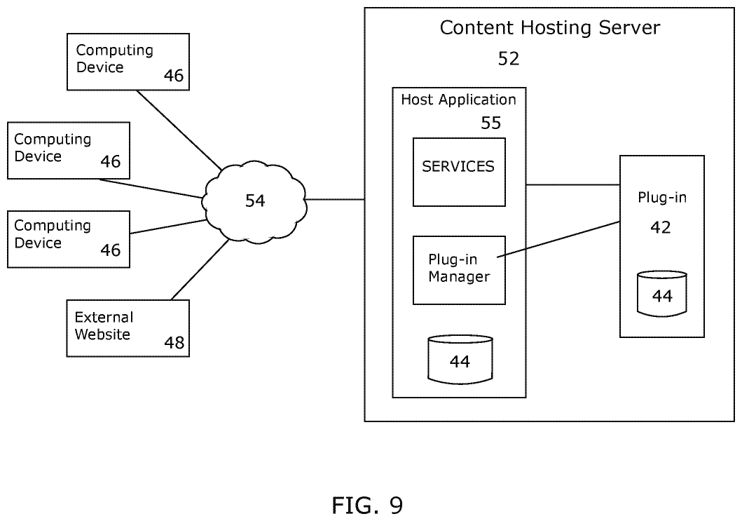

FIG. 9 illustrates a high-level block diagram illustrating a system environment suitable for the present method to operate. As illustrated, the system environment includes one or more computing devices 46, external websites 48, network 54 and a content hosting server 52 having a host application and a plug-in software component. Computing device 46 can be any device that can receive user input and can transmit and receive data via the network 54. Thus, computing device 46 can be smart phones, tablets, laptop computers, desktop computers, or another other known computing device. The computing device 46 allows a user to communicate via network 54 (any combination of local area/wide area network) to the content hosting server 52.

Content hosting server 52 is a high-level view of the application service offered. Thus, some components, such as load balancers, security services, and other components are not shown. The reader will understand that the present environment can include all known components in order to offer the application service and plug-in and should not be limited to the components shown. Content hosting server 52 includes the host application 55 and plug-in 42. The host application provides services which the plug-in can use, including a protocol for the exchange of data with plug-ins and a way for the plug-in to register itself with the host application. The host application provides services to the plug-in and allows the plug-in to supplement the host application with additional functionality and features. The host application and plug-in may include several databases 44 which act to store pertinent information for the present method. For example, databases 44 can include stores for registrations of users, advertisement data, content data, transaction data and any other necessary data to run and operate each software program.

The system environment allows a user to communicate and interact with one another as well as access social media (or other content) of host application and advertiser content of plug-in. Additionally, although not shown, the present environment may include additional connected servers. For example, a separate server may be desirable to host plug-in in order to quickly and efficiently sort and deliver advertisements, as described herein. Additionally, a web server may be desirable to link the social networking service via the network to one or more user devices.

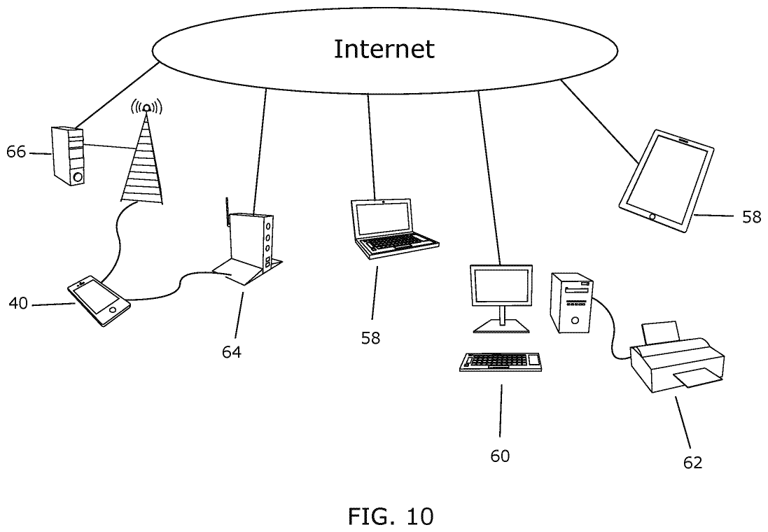

FIG. 10 depicts exemplary hardware that the present method may be carried out upon. Communications are preferably conducted over the internet (or network) since this will give the broadest possible access to portable devices. User may access the present invention through the internet via mobile device 40 through cellular service provider 66 or via “wi-fi” through wireless router 64. Wireless router 64 may also provide internet access to laptop computer 56 and tablet computer 58 such that user may access the present invention on laptop computer 56. Desktop computer 60 may also be used to access the present invention via the internet. Further, printer 62 may be used to print various redeemed tiles 36 if user prefers a physical copy of the redeemed coupon, discount, or promotion code.

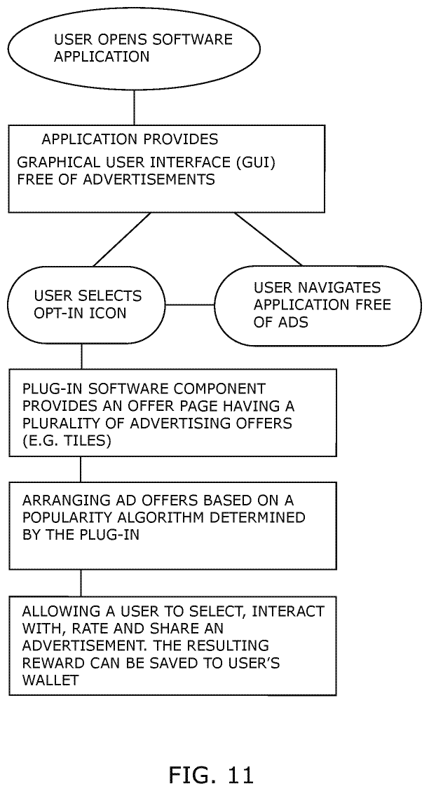

FIG. 11 is a flow chart illustrating the steps of the present method. First, a user opens a software application. Although this method describes and shows a social media application, the present method can be used with any software application that utilizes advertisements. Many software applications provide free or reduced cost services relying on advertisements to monetize the application. The user experience of the services offered are often diminished by the incessant advertisements. The present method allows an application to continue to provide free or reduced cost services monetized by advertisements, along with the streamlined, clean experience of services free of advertisements where ads are found on a separate opt-in plug-in. Thus, upon opening the software application on the user's computing device, the user is presented with a graphical user interface that is free of advertisements. In one example, a news feed is provided as content which is free of advertisements. However, this could be any graphical display of content offering application services free of ads.

A user can opt to continue to navigate the application free of ads or select an opt-in icon provided on the application graphical display (application graphical user interface). When the user selects the opt-in icon, the plug-in software component provides an offer page (on plug-in graphical user interface) having a plurality of advertising offers. Note that although the terms first and plug-in graphical user interface are used herein—there can be many different user interfaces and the terms “first” and “second” should in no way limit the number of or relationship between the user interfaces or graphical displays provided. Here, the application graphical user interface is associated with all of the content of the host application (including index page and all subpages) and plug-in graphical user interface is associated with all of the content of the plug-in or advertising content (including the tile wall, wallet and pop-up content, but not limited thereto). In one embodiment, the advertising offers appear as tiles on a “tile wall.” The offer page containing the advertisement offers are arranged by the plug-in based on a popularity algorithm described herein. The algorithm may simply ascribe a greater value to the advertisements that have accrued the greatest number of selections by users, and then automatically and continuously arrange the advertisements with the greatest value at the top of the offer page (or tile wall). However, the algorithm may also use a series of data points to arrange the ads from most to least popular, such that the user views the most popular advertisements first when visiting the offer page. The offer page also can be manually filtered by the user, as described herein, to provide a customized view to each user. The plug-in then allows a user to select an advertisement and provides the user with a pop-up 32, such as a questionnaire, survey or other information. The user can interact with the pop-up 32 (shown in FIGS. 4 and 5) and claim a coupon, free-offer or other reward. The present plug-in software component may also provide the user with a way to rank the advertisement after interacting with the ad. This can be done by allowing the user to click on a set number of stars (e.g. click 1, 2 or 3 stars to rate) or a simple thumbs up or thumbs down rating. Any method of rating the ad could be used. Finally, the plug-in allows the user to share the advertisement with another user of the application by interacting with the software application to do the same. After interaction with the advertisement the plug-in will automatically save the reward received (promotion code, giveaway, discount code, coupon) to the user's “wallet” as shown in FIG. 6 and described herein. The reader will appreciate that, although not shown as a step in the method, the user can close the application at any step of the method.

Although the preceding descriptions provide significant detail as to specific embodiments of the invention, they are by no means an exhaustive description of all possible embodiments. Thus, the scope of the invention should be fixed by the following claims rather than the examples given.

Having described my invention, I claim:

1. A method allowing a user to opt-in to selected advertising over a network, comprising:
(a) providing content on a application graphical user interface to a user over said network, said content being displayed to said user free of advertising offers;
(b) providing an opt-in icon to said user on said application graphical user interface;
(c) in response to said user selecting said opt-in icon on said application graphical user interface, transmitting to said user over said network an opt-in offer page containing a plurality of advertising offers on a plug-in graphical user interface;
(d) providing said plurality of advertising offers to said user on a plug-in graphical user interface; and
(e) in response to said user selecting one of said plurality of advertising offers, providing advertising content corresponding to said selected one of said plurality of advertising offers over said network allowing said user to interact with said advertising content.

2. The method allowing a user to opt-in to selected advertising over a network as recited in claim 1, wherein each of said advertising offers is presented as an advertising tile.

3. The method allowing a user to opt-in to selected advertising over a network as recited in claim 2, wherein:
(a) said advertising offers are provided to multiple users;
(b) selections made by each user for each advertising offer are recorded to determine a total number of selections for a particular advertising offer by all users; and
(c) an advertising tile having a greater number of user selections is displayed more prominently.

4. The method allowing a user to opt-in to selected advertising over a network as recited in claim 3, wherein said more prominent display comprises a higher position on said graphical display.

5. The method allowing a user to opt-in to selected advertising over a network as recited in claim 1, further comprising providing a response incentive for a particular advertising offer.

6. The method allowing a user to opt-in to selected advertising over a network as recited in claim 5, wherein said response incentive comprises a coupon.

7. The method allowing a user to opt-in to selected advertising over a network as recited in claim 5, further comprising providing a user-specific wallet for storing said response incentives for future use.

8. The method allowing a user to opt-in to selected advertising over a network as recited in claim 7, wherein said wallet allows a first user to transfer a response incentive to a second user.

9. The method allowing a user to opt-in to selected advertising over a network as recited in claim 2, further comprising providing a response incentive for a particular advertising offer.

10. The method allowing a user to opt-in to selected advertising over a network as recited in claim 3, further comprising providing a response incentive for a particular advertising offer.

11. A method allowing a user to opt-in to selected advertising over a network, comprising:
(a) providing a news feed to a user over said network, said news feed being configured to be displayed on a graphical display;
(b) said news feed including an opt-in icon configured to be displayed on said graphical display;
(c) in response to said user selecting said opt-in icon on said graphical display, transmitting to said user over said network an opt-in offer page containing a plurality of advertising offers, said opt-in offer page being configured to display on said graphical display; and
(d) in response to said user selecting a particular one of said plurality of advertising offers, providing advertising content corresponding to said selected particular one of said plurality of advertising offers over said network as part of said news feed to said user.

12. The method allowing a user to opt-in to selected advertising over a network as recited in claim 11, wherein each of said advertising offers is presented as an advertising tile.

13. The method allowing a user to opt-in to selected advertising over a network as recited in claim 12, wherein:
(a) said news feed and said advertising offers are provided to multiple users;
(b) selections made by each user for each advertising offer are recorded to determine a total number of selections for a particular advertising offer by all users; and
(c) an advertising tile having a greater number of user selections is displayed more prominently.

14. The method allowing a user to opt-in to selected advertising over a network as recited in claim 13, wherein said more prominent display comprises a higher position on said graphical display.

15. The method allowing a user to opt-in to selected advertising over a network as recited in claim 11, further comprising providing a response incentive for a particular advertising offer.

16. The method allowing a user to opt-in to selected advertising over a network as recited in claim 15, wherein said response incentive comprises a coupon.

17. The method allowing a user to opt-in to selected advertising over a network as recited in claim 15, further comprising providing a user-specific wallet for storing said response incentives for future use.

18. The method allowing a user to opt-in to selected advertising over a network as recited in claim 17, wherein said wallet allows a first user to transfer a response incentive to a second user.

19. The method allowing a user to opt-in to selected advertising over a network as recited in claim 12, further comprising providing a response incentive for a particular advertising offer.

20. The method allowing a user to opt-in to selected advertising over a network as recited in claim 13, further comprising providing a response incentive for a particular advertising offer.
